(19) United States
(12) Patent Application Publication
(10) Pub. No.: US 2026/0238767 A1
(43) Pub. Date: Aug. 13, 2026

(54) Methods and Apparatus of Storing Temporal Models for Cross-Component Prediction Merge Mode in Indexed Table

(71) Applicant: MEDIATEK INC., Hsinchu City (TW)

(72) Inventors: Hsin-Yi TSENG, Hsinchu City (TW); Chia-Ming TSAI, Hsinchu City (TW); Cheng-Yen CHUANG, Hsinchu City (TW); Ching-Yeh CHEN, Hsinchu City (TW); Chih-Wei HSU, Hsinchu City (TW); Yi-Wen CHEN, San Jose, CA (US); Tzu-Der CHUANG, Hsinchu City (TW)

(21) Appl. No.: 19/471,776

(22) PCT Filed: Jun. 20, 2024
(86) PCT No.: PCT/CN2024/100338

§ 371 Date: Oct. 2, 2025

Related U.S. Application Data
(60) Provisional application No. 63/509,038, filed on Jun. 20, 2023.

(51) Int. Cl. H04N 19/107; H04N 19/119; H04N 19/136; H04N 19/176; H04N 19/186; H04N 19/70

(52) U.S. Cl. CPC H04N 19/107; H04N 19/119; H04N 19/136; H04N 19/176; H04N 19/186; H04N 19/70

(57) ABSTRACT

A method and apparatus of CCM prediction using one or more indexed tables are disclosed. According to this method, if the current block is coded using a cross-component related tool, a target index value stored in one or more picture-level index buffers is retrieved according to a location of the current block; target CCM (Cross-Component Model) information stored in one or more indexed tables is determined according to the target index value if the target index value points to valid CCM information, wherein said one or more indexed tables store CCM information associated with one or more previous coded pictures; and the second-colour block is encoded or decoded using coding information comprising the target CCM information and the first-colour block.

### CROSS REFERENCE TO RELATED APPLICATIONS

The present invention is a non-Provisional application of and claims priority to U.S. Provisional Patent Application No. 63/509,038, filed on Jun. 20, 2023. The U.S. Provisional Patent Application is hereby incorporated by reference in its entirety.

### FIELD OF THE INVENTION

The present invention relates to video coding system. In particular, the present invention relates to chroma component coding using prediction based on a cross-component model information associated with one or more previous coded pictures, wherein the CCM information is stored in a one or more indexed tables and referenced by using an index value stored in a picture-level index buffer.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

### Convolutional Cross-Component Model (CCCM)

In CCCM, a convolutional model is applied to improve the chroma prediction performance. The convolutional model has 7-tap filter consisting of a 5-tap plus sign shape spatial component, a nonlinear term and a bias term. The input to the spatial 5-tap component of the filter consists of a center (C) luma sample which is collocated with the chroma sample to be predicted and its above/north (N), below/south(S), left/west (W) and right/east (E) neighbours as illustrated in FIG. 2.

The nonlinear term (denoted as P) is represented as power of two of the centre luma sample C and scaled to the sample value range of the content:

$$P = ( C ⋆ C + midVal ) >> bitDepth .$$

That is, for 10-bit content it is calculated as:

$$P = ( C * C + 512 ) >> 10.$$

The bias term (denoted as B) represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B .$$

### Gradient Linear Model (GLM)

For YUV 4:2:0 colour format, a gradient linear model (GLM) method can be used to predict the chroma samples from luma sample gradients. Two modes are supported: a two-parameter GLM mode and a three-parameter GLM mode.

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged:

$$C = α \cdot G + β .$$

In the three-parameter GLM, a chroma sample can be predicted based on both the luma sample gradients and down-sampled luma values with different parameters. The model parameters of the three-parameter GLM are derived from 6 rows and columns adjacent samples by the LDL decomposition based MSE minimization method as used in the CCCM.

$$C = {α}_{0} \cdot G + {α}_{1} \cdot L + {α}_{2} \cdot β$$

For signalling, when the CCLM mode is enabled to the current CU, one flag is signalled to indicate whether GLM is enabled for both Cb and Cr components; if the GLM is enabled, another flag is signalled to indicate which of the two GLM modes is selected and one syntax element is further signalled to select one of 4 gradient filters for the gradient calculation.

Four gradient filters (310-340) are enabled for the GLM, as illustrated in FIG. 3.

In order to improve the coding efficiency for a system using cross-component models from previous coded pictures, methods and apparatus of using one or more indexed tables for storing cross-component model (CCM) information associated with previous coded pictures are disclosed and the CCM is retrieved according to an index value stored in a picture-level index buffer.

### BRIEF SUMMARY OF THE INVENTION

A method and apparatus for coding colour pictures using coding tools including one or more cross component models related modes are disclosed. According to this method, input data associated with a current block comprising a first-colour block and a second-colour block is received, wherein the input data comprise pixel data to be encoded at an encoder side or data associated with the current block to be decoded at a decoder side. If the current block is coded using a cross-component related tool: a target index value stored in one or more picture-level index buffers is retrieved according to a location of the current block; target CCM (Cross-Component Model) information stored in one or more indexed tables is determined according to the target index value if the target index value points to valid CCM information, wherein said one or more indexed tables store CCM information associated with one or more previous coded pictures and the second-colour block is encoded or decoded using coding information comprising the target CCM information and the first-colour block.

In one embodiment, said one or more indexed tables to store the CCM information correspond to one or more picture-level tables. In one embodiment, one indexed table is created to store the CCM information from each of previous coded pictures. In one embodiment, one indexed table is created to store the CCM information from all the previous coded pictures. In one embodiment, one indexed table is created to store the CCM information for the previous coded pictures associated with each temporal ID (Identifier). In one embodiment, the CCM information from a layer for the previous coded pictures with a same temporal ID is stored in a same table.

In one embodiment, multiple indexed tables are used to store the CCM information associated with one previous coded picture. In one embodiment, one previous coded picture is divided into multiple regions and each of the multiple regions uses an individual indexed table.

In one embodiment, the target index value for the target CCM information at the location of the current block is saved at the location of the current block in said one or more picture-level index buffers of a current picture being encoded or decoded after storing the target CCM information into one or more corresponding indexed tables of the current block of the current picture being encoded or decoded. In one embodiment, when storing the target CCM information at the location of the current block into said one or more indexed tables, similarity between the target CCM information and existing CCM information in said one or more indexed tables are compared. In one embodiment, if the target CCM information is similar to the existing CCM information in one or more entries of said one or more indexed tables, the target CCM information is not stored. In one embodiment, a corresponding index associated with the existing CCM information is stored at the location of the current block in said one or more picture-level index buffers. In one embodiment, the similarity is determined by comparing mode, one or more parameters, or both between the target CCM information and the existing CCM information.

In one embodiment, if no CCM information is available at the location of the current block, a corresponding index value at the location of the current block in said one or more picture-level index buffers is set to indicate no CCM information available. In another embodiment, if no CCM information is available at a target location of a current picture and if a corresponding index value at the target location in said one or more picture-level index buffers of a collocated picture indicates saved CCM information in one or more corresponding indexed tables, the saved CCM information is stored at the indexed table corresponding to the target location of the current picture and the target index value for the saved CCM information in the indexed table corresponding to the target location of the current picture is saved at the target location in said one or more picture-level index buffers of the current picture.

In one embodiment, when deleting to-be-deleted CCM information from said one or more indexed tables, all index values in said one or more picture-level index buffers indicating to use the to-be-deleted CCM information are reset to indicate no CCM information available. In another embodiment, when deleting to-be-deleted CCM information from said one or more indexed tables, all index values in said one or more picture-level index buffers having values greater than N are decreased by 1 if the index value for the to-be-deleted CCM information is N.

In one embodiment, a maximum number of entries for said one or more indexed tables is limited to a maximum size. In one embodiment, a high-level syntax is signalled or parsed in SPS (Sequence Parameter Size), PPS (Picture Parameter Size), PH (Picture Header) or SH (Slice Header) to indicate the maximum size.

In one embodiment, said one or more indexed tables reach the maximum size, oldest CCM information is deleted to free up space for new CCM information in said one or more indexed tables.

In one embodiment, said one or more indexed tables are reset at beginning of encoding/decoding of an IDR (Instantaneous Decoder Refresh) or CRA (Clean Random Access) picture or after said encoding/decoding of the IDR or CRA picture. In one embodiment, one or more indexes stored in said one or more picture-level index buffers are only referenced by a coding block larger than or equal to a smallest coding unit.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates the 5-tap plus sign shape spatial component of the CCCM filter consisting of a centre (C) luma sample which is collocated with the chroma sample to be predicted and its above/north (N), below/south(S), left/west (W) and right/east (E).

FIG. 3 shows 4 gradient patterns for GLM.

FIG. 4 illustrates the 5 neighbouring blocks used for deriving spatial merge candidates for VVC.

FIG. 5 illustrates an example of inheriting temporal neighbouring model parameters.

FIGS. 6A-B illustrates two search patterns for inheriting non-adjacent spatial neighbouring models.

FIG. 7 illustrates a flowchart of an exemplary video coding system that uses one or more indexed tables for storing cross-component model (CCM) information associated with previous coded pictures and the CCM is retrieved according to an index value stored in a picture-level index buffer.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

The following methods are proposed to reduce the storage requirements when using cross-component prediction related tools

### I. Inheriting Neighbouring Model Parameters

When applying cross-component prediction coding tool on the current block to generate prediction signals, the cross-component model (CCM) information (more details in section entitled: “Inheriting CCM information”) including model parameters can be inherited from neighbouring blocks.

In one embodiment, if the inherited neighbour block is coded in CCLM mode, the final scaling parameter of the current block is inherited from the neighbouring blocks. Once the final scaling parameter is determined, the offset parameter (e.g., β in CCLM) is derived based on the inherited scaling parameter and/or the average value of neighbouring luma and chroma samples of the current block.

In one embodiment, if the inherited neighbour block is coded in CCLM mode, after inheriting model parameters, the offset parameter can be inherited or can be further refined by dB. For example, if the final offset parameter is inherited from a selected neighbouring block, and the inherited offset parameter is β′ₙₑᵢ, then the final scaling parameter is (β′ₙₑᵢ+dB). dB can be zero.

In one embodiment, if the inherited neighbour block is coded with CCCM, the filter coefficients (cᵢ) are inherited. The offset parameter (e.g., c₆×B or c₆ in CCCM) can be re-derived based on the inherited parameter and the average value of neighbouring corresponding position luma and chroma samples of the current block.

In one embodiment, if the inherited neighbour block is coded with CCCM, the filter coefficients (cᵢ) are inherited. The offset parameter (e.g., c₆×B or c₆ in CCCM) is also inherited and is not re-derived.

In one embodiment, if the inherited candidate applies the GLM gradient pattern to its luma reconstruction samples, the current block shall also inherit the GLM gradient pattern of the candidate and apply to the current luma reconstruction samples.

In one embodiment, if the inherited neighbour block is coded with multiple cross-component models (e.g., MMLM, or CCCM with multi-model), the classification threshold is also inherited to classify the neighbouring samples of the current block into multiple groups, and the inherited multiple cross-component model parameters are further assigned to each group.

### I.1 Inheriting CCM Information

In one embodiment, the cross-component model (CCM) information of inherited cross-component model can be stored together with the inherited model parameters. The CCM information can be inherited together with the inherited model parameters. The prediction of the current block can be generated based on the inherited CCM information and inherited model parameters. The CCM information can include but not limited to prediction mode (e.g., CCLM, MMLM, CCCM, 2-parameter GLM, 3-parameter GLM), model index for indicating which model shape is used in convolutional model, classification threshold for multi-model, information to indicate that non-downsampled samples are used in convolutional model, down-sampling filter flag, down-sampling filtering index when multiple down-sampling filters are used, number of neighbouring lines used to derive model, types of templates used to derive model, post-filtering flag and model parameters.

In one embodiment, a mixed CCCM model consisting of various terms (e.g., spatial term, gradient term, location term, non-linear term and bias term) can be inherited. In addition to storing model parameters, a prediction mode can be stored in the CCM information to indicate that the inherited model is a mixed CCCM model consisting of various terms. If there are multiple types of mixed CCCM models, a model index can also be stored in the CCM information to indicate which type of mixed CCCM model is inherited. For example, gradient and location based CCCM (GL-CCCM) proposed in JVET-AB0119 (Ramin G. Youvalari, et al., “Non-EE2: Gradient and location based convolutional cross-component model (GL-CCCM) for intra prediction”, Joint Video Exploration Team (JVET) of ITU-T SG 16 WP 3 and ISO/IEC JTC 1/SC 29/WG 11, 28th Meeting, Mainz, DE, 20-28 Oct. 2022, Document: JVET-AB0119) is a mixed CCCM model which consists of one spatial term in centre position, two gradient terms for the horizontal direction and the vertical direction, two location terms X and Y for the relative horizontal location and relative vertical location, one non-linear term and one bias term. A prediction mode can be stored in the CCM information to indicate that the inherited model is a GL-CCCM model.

### 1.2 Inheriting Spatial Neighbouring Model Parameters

In one embodiment, the inherited model parameters can be from a block that is an immediate neighbouring block. The models from blocks at pre-defined positions are added into the candidate list in a pre-defined order.

In one embodiment, the pre-defined positions and the pre-defined order can be the same as those of spatial candidates for inter merge mode.

In one embodiment, the pre-defined positions can be the positions depicted in FIG. 4. The pre-defined order can be B₀, A₀, B₁, A₁ and B₂.

In one embodiment, assume the position, width and height of the current block are (x, y), W and H respectively, the pre-defined positions can include positions immediate above the current block, such as (x+W>>1, y−1) or (x+(W+1)>>1, y−1), if W is greater than or equal to a threshold TH. The pre-defined positions can also include positions immediate left to the current blocks, such as (x−1, y+H>>1) or (x−1, y+(H+1)>>1), if H is greater than or equal to a threshold TH. TH can be 2, 4, 8, 16, 32, or 64.

In one embodiment, there is a maximum number of inherited models from spatial neighbours that can be added into the candidate list, and the maximum number is smaller than the number of pre-defined positions.

### I.3 Inheriting Temporal Neighbouring Model Parameters

In one embodiment, if the current slice/picture is a non-intra slice/picture, the inherited model parameters can be from the block in the previous coded slices/pictures.

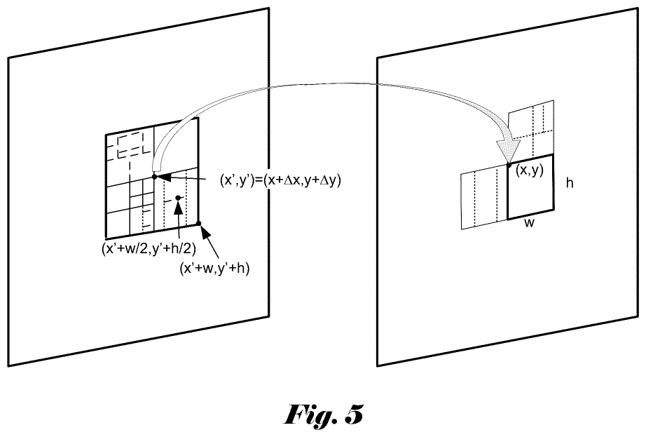

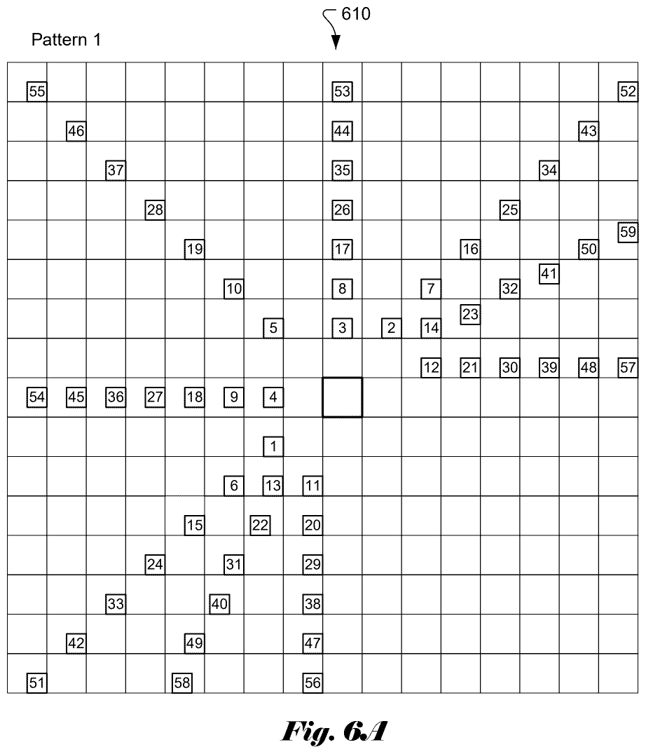

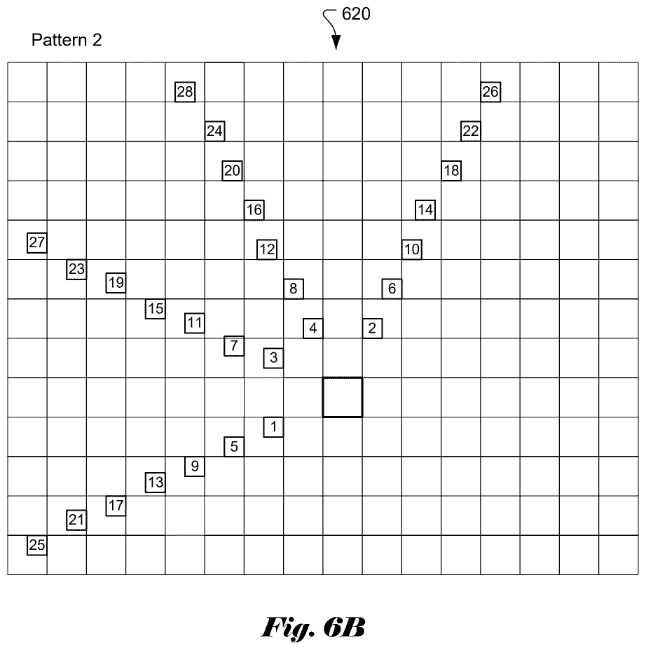

In one embodiment, if the current slice/picture is a non-intra slice/picture, the inherited model parameters can be from the block in the previous coded slices/pictures. For example, as shown in FIG. 5, the current block position is at (x, y) and the block size is w×h. The inherited model parameters can be from the block at position (x′, y′), (x′, y′+h/2), (x′+w/2, y′), (x′+w/2, y′+h/2), (x′+w, y′), (x′, y′+h), or (x′+w, y′+h) of the previous coded slices/picture, where x′=x+Δx and y′=y+Δy. In one embodiment, if the prediction mode of the current block is intra, Δx and Δy are set to 0. If the prediction mode of the current block is inter, Δx and Δy are set to the horizontal and vertical motion vectors of the current block. In one embodiment, if the current block is inter bi-prediction, Δx and Δy are set to the horizontal and vertical motion vectors in reference picture list 0. In one embodiment, if the current block is inter bi-prediction, Δx and Δy are set to the horizontal and vertical motion vectors in reference picture list 1.

In one embodiment, if the current block is inter bi-prediction, the inherited model parameters can be from the block in the previous coded slices/pictures in the reference lists. For example, if the horizontal and vertical motion vectors in reference picture list 0 is Δx_{L0} and Δy_{z0}, the motion vector can be scaled to other reference pictures in the reference list 0 and 1. If the motion vector is scaled to the i^{th} reference picture in the reference list 0 as (Δx_{L0,i0}, Δy_{L0,i0}). The model can be from the block in the i^{th} reference picture in the reference list 0, and Δx and Δy are set to (Δx_{L0,i0}, Δy_{L0,i0}). For another example, if the horizontal and vertical motion vectors in reference picture list 0 is Δx_{L0} and Δy_{L0}, the motion vector is scaled to the i^{th} reference picture in the reference list 1 as (Δx_{L0,i1}, Δy_{L0,i1}). The model can be from the block in the i^{th} reference picture in the reference list 1, and Δx and Δy are set to (Δx_{L0,i1}, Δy_{L0,i1}).

In one embodiment, if the current slice/picture is a non-intra slice/picture, the inherited model parameters can be from the block in the previous coded slices/pictures. In one embodiment, the current block position is at (x, y) and the block size is w×h. The two value sets αₓ and α_{y} are defined as:

$${α}_{x} = \{ {α}_{x 1} , {α}_{x 2} , {α}_{x 3} , … , {α}_{x n} \} , {α}_{x i} < {α}_{x j} if i < j$$

$${α}_{y} = \{ {α}_{y 1} , {α}_{y 2} , {α}_{y 3} , … , {α}_{y n} \} , {α}_{y i} < {α}_{y j} if i < j$$

All values in ax and ay are positive numbers. Let (x_{mid}, y_{mid})=(x+w/2, y+h/2). The inherited model parameters can be from the block at positions (x_{mid}±αₓᵢ×w, y_{mid}±α_{yi}×h), (x_{mid}±αₓᵢ×w, y_{mid}), (x_{mid}, y_{mid}+α_{yi}×h) of the previous coded slices/picture.

In one sub-embodiment, αₓ=α_{y}. For example, αₓ=α_{y}={1, 2, 3, 4, 5}.

In another sub-embodiment, αₓ≠α_{y}. For example, α_x={1/2, 1, 3/2, 2, 5/2} and α_{y}={1, 2, 3, 4, 5}.

In another embodiment, the current block position is at (x, y) and the block size is w×h. The inherited model parameters can be from the block at positions (x+αₓᵢ×w, y+α_{yi}×h), (x+αₓᵢ×w, y−α_{yi}×h), (x−αₓᵢ×w, y+α_{yi}×h), (x−αₓᵢ×w, y−α_{yi}×h), (x+αₓᵢ×w, y), (x−αₓᵢ×w, y), (x, y+α_{yi}×h), or (x, y−α_{yi}×h) of the previous coded slices/picture.

In one sub-embodiment, αₓ=α_{y}. For example, αₓ=α_{y}={1, 2, 3, 4, 5}.

In another sub-embodiment, αₓ≠α_{y}. For example, α_x={1/2, 1, 3/2, 2, 5/2} and α_{y}={1, 2, 3, 4, 5}.

In one embodiment, the models from the positions closer to (x_{mid}, y_{mid}) are added into the final merge candidate list first. In another embodiment, the models from the positions closer to (x, y) are added into the final merge candidate list first.

In one embodiment, let δx and δy be two fixed positive numbers. The inherited model parameters can be from the block at positions (x_{mid}+αₓᵢ×δx, y_{mid}+α_{yi}×δy), (x_{mid}+αₓᵢ×δx, y_{mid}−α_{yi}×δy), (x_{mid}−αₓᵢ×δx, y_{mid}+α_{yi}×δy), (x_{mid}−αₓᵢ×δx, y_{mid}−α_{yi}×δy), (x_{mid}+αₓᵢ×δx, y_{mid}), (x_{mid}−αₓᵢ×δx, y_{mid}), (x_{mid}, y_{mid}+α_{yi}×δy), or (x_{mid}, y_{mid}−α_{yi}×δy) of the previous coded slices/picture.

In another embodiment, the current block position is at (x, y) and the block size is w×h. Let δx and δy be two fixed positive numbers The inherited model parameters can be from the block at positions (x+αₓᵢ×δx, y+α_{yi}×δy), (x+αₓᵢ×δx, y−α_{yi}×δy), (x−αₓᵢ×δx, y+α_{yi}×δy), (x−αₓᵢ×δx, y−α_{yi}×δy), (x+αₓᵢ×δx, y), (x−αₓᵢ×δx, y), (x, y+α_{yi}×δy), or (x, y−α_{yi}×δy) of the previous coded slices/picture.

In another embodiment, the current block position is at (x, y) and the block size is w×h. The inherited model parameters can be from the block at some pre-defined positions (x′, y′) of the previous coded slices/picture. For one example, the positions are inside the corresponding area of the current encoding block, i.e., x≤x′<x+w and y≤y′<y+h. The inherited model parameters can be from the block at (x, y), (x+w−1, y), (x, y+h−1), (x+w−1, y+h−1), or (x+w/2, y+h/2). For another example, the positions are outside of the corresponding area of the current encoding block, i.e., x′<x+ or x′≥x+w, and y′<yor y′≥y+h. The inherited model parameters can be from the block at (x−1, y), (x, y−1), (x−1, y−1), (x+w, y), (x+w−1, y−1), (x+w, y−1), (x, y+h), (x−1, y+h−1), (x−1, y+h), (x+w, y+h−1), (x+w−1, y+h), or (x+w, y+h).

In one embodiment, the inherited model parameters can be from the block at some pre-defined positions. The pre-defined positions and the inclusion order can be the same as those of inter merge mode.

The previous coded picture which the inherited parameter model is from is referred as the collocated picture hereafter.

In one embodiment, the previous coded picture where the inherited parameter model is from (i.e., the collocated picture) is one of the pictures in the reference lists.

In one embodiment, the collocated picture can be the same as the collocated picture of inter merge mode.

In one embodiment, the collocated picture is signalled in the picture/slice header. The reference list and the reference index are signalled in the picture/slice header. For example, the collocated picture is selected as L0[0]. For another example, the collocated picture is selected as L1[0].

In one embodiment, the collocated picture is selected as the picture in the reference lists whose POC difference between it and the current picture is the smallest. For example, if the POC of current picture is 8, the POCs of pictures in reference list 0 are {7, 6, 5, 0} and POCs of pictures in reference list 1 are {7, 6, 5, 4}, then L0[0] (equivalent to L1[0]) is selected since its POC difference is the smallest.

In one sub-embodiment, if there are two pictures whose POC difference between it and the current picture are both the smallest, the picture with the smaller POC is selected.

In one sub-embodiment, if there are two pictures whose POC difference between it and the current picture are both the smallest, the picture with the larger POC is selected.

In another sub-embodiment, if there are two pictures whose POC difference between the respective picture and the current picture are both the smallest, the picture with smaller QP difference between the respective picture and the current picture is selected.

In another sub-embodiment, if there are two pictures whose POC difference between the respective picture and the current picture are both the smallest, the picture with the smaller QP is selected.

In another sub-embodiment, if there are two pictures whose POC difference between the respective picture and the current picture are both the smallest, the picture with the larger QP is selected.

In one embodiment, the collocated picture is selected as the picture in the reference lists whose QP difference between the respective picture and the current picture is the smallest. For example, if the QP of current picture is 28, and the QPs of the pictures in reference list 0 are {19, 26, 23} and the QPs of the pictures in reference list 1 are {23, 22, 21}. Then L0[1] is selected.

In one sub-embodiment, if there are more than one picture in the reference lists whose QP difference between the respective picture and the current picture are the smallest, the picture with the smaller QP is selected.

In another sub-embodiment, if there are more than one picture in the reference lists whose QP difference between the respective picture and the current picture are the smallest, the picture with the larger QP is selected.

In another sub-embodiment, if there are more than one picture whose QP difference between it and the current picture are the smallest, the picture with the smaller POC distance is selected.

In one embodiment, the collocated picture is selected as the picture in the reference lists whose QP is the smallest.

In another embodiment, the collocated picture is selected as the picture in the reference lists whose QP is the largest.

In one embodiment, the previous coded picture which the inherited parameter model is from, i.e., the collocated picture, is the most recently coded I-picture. The cross-component model information of the most recently coded I-slice/picture is stored in a long-term reference buffer.

In one embodiment, the collocated picture and the pre-defined positions where the inherited parameter model is from is determined by the motion vector of a neighbouring block. For example, if the current block position is at (x, y) and the block size is w×h. The inherited model parameters can be from the block at position (x′, y′), (x′, y′+h/2), (x′+w/2, y′), (x′+w/2, y′+h/2), (x′+w, y′), (x′, y′+h), or (x′+w, y′+h) of the collocated picture, where x′=x+Δx and y′=y+Δy.

In one sub-embodiment, Δx and Δy are set to the L0 horizontal and vertical motion vectors of the neighbouring block, and the collocated picture is the L0 reference picture indicated by the L0 motion vector of the neighbouring block.

In one sub-embodiment, if the neighbouring block is inter bi-prediction, Δx and Δy are set to the L1 horizontal and vertical motion vectors of the neighbouring block, and the collocated picture is the L1 reference picture indicated by the L1 motion vector of the neighbouring block.

In one sub-embodiment, the neighbouring block is the left block of the current block.

In another sub-embodiment, the neighbouring block is the above block of the current block.

In one embodiment, the pre-defined positions in the previous coded slices/pictures where the inherited parameter model is from is determined by the motion vector of a neighbouring block. Let Δx and Δy be the horizontal and vertical displacements determined based on the selected motion vector of the neighbouring block, the current block position is at (x, y) and the block size is w×h. The inherited model parameters can be from the block at position (x′, y′), where x′=x+Δx and y′=y+Δy, or where x′=x+w/2+Δx and y′=y+h/2+Δy.

In another embodiment, the inherited model parameters can also be from the block positions in the patterns described in earlier paragraphs. The positions are centred at (x′, y′), where x′=x+Δx and y′=y+Δy, or where x′=x+w/2+Δx and y′=y+h/2+Δy. That is, denote the pre-defined positions as (x₁, y₁), (x₂, y₂), (x₃, y₃), . . . , (x_{N}, y_{N}), the inherited model parameters can be from (x₁+Δx, y₁+Δy), (x₂+Δx, y₂+Δy), (x₃+Δx, y₃+Δy), . . . , (x_{N}+Δx, y_{N}+Δy), where Δx and Δy are the horizontal and vertical displacements determined based on the selected motion vector of the neighbouring block. For example, let the current block size be w×h. The two value sets ax and ay are defined as:

$${α}_{x} = \{ {α}_{x 1} , {α}_{x 2} , {α}_{x 3} , … , {α}_{x n} \} , {α}_{x i} < {α}_{x j} if i < j$$

$${α}_{y} = \{ {α}_{y 1} , {α}_{y 2} , {α}_{y 3} , … , {α}_{y n} \} , {α}_{y i} < {α}_{y j} if i < j$$

All values in ax and ay are positive numbers. The inherited model parameters can be from the block at positions (x′+αₓᵢ×w, y′+dy; x h), (x′+αₓᵢ×w, y′−α_{yi}×h), (x′−αₓᵢ×w, y′+α_{yi}×h), (x′−xₓᵢ×w, y′−α_{yi}×h), (x′+αₓᵢ×w, y′), (x′−αₓᵢ×w, y′), (x′, y′+α_{yi}×h), or (x′, y′−α_{yi}×h) of the previous coded slices/picture. For another example, let δx and δy be two fixed positive numbers. The inherited model parameters can be from the block at positions (x′+αₓᵢ×δx, y′+α_{yi}×δy), (x′+αₓᵢ×δx, y′−α_{yi}×δy), (x′−αₓᵢ×δx, y′+α_{yi}×δy), (x′−αₓᵢ×δx, y′−α_{yi}×δy), (x′+αₓᵢ×δx, y′), (x′−αₓᵢ×δx, y′), (x′, y′+α_{yi}×δy), or (x′, y′−α_{yi}×δy) of the previous coded slices/picture. For another example, the inherited model parameters can be from the block at some pre-defined positions relative to (x′, y′) of the previous coded slices/picture. The positions can be (x′, y′), (x′+w−1, y′), (x′, y′+h−1), (x′+w−1, y′+h−1), or (x′+w/2, y′+h/2). For another example, the positions can be (x′−1, y′), (x′, y′−1), (x′−1, y′−1), (x′+w, y′), (x′+w−1, y′−1), (x+w, y′−1), (x′, y′+h), (x′−1, y′+h−1), (x′−1, y′+h), (x′+w, y′+h−1), (x′+w−1, y′+h), or (x′+w, y′+h).

In one embodiment, the neighbouring block can be at a pre-defined position. For example, the position can be at the A₀ position as depicted in FIG. 4. The pre-defined position can also be at A₁, B₀, B₁, B₂. If the block at the pre-defined position is not an inter block, no neighbouring block is selected.

In another embodiment, when selecting the neighbouring block, there can be a list of pre-defined positions. The positions are placed according to the checking order. For example, the positions can be B₀, A₀, B₁, A₁ and B₂ as depicted in FIG. 4. The selected neighbouring block can be the first position in the list that is an inter block. The L0 motion vector is selected. If the L0 motion vector is not available, select the L1 motion vector. For another example, the L1 motion vector is selected. If the L1 motion vector is not available, select the L0 motion vector

In another embodiment, if the collocated picture has been determined (e.g., it can be determined with the methods described in earlier paragraphs in this section), the positions in the list of pre-defined positions are checked in the pre-defined checking order. The selected motion vector is the first whose reference picture is the collocated picture. For example, the positions can be B₀, A₀, B₁, A₁ and B₂ as depicted in FIG. 4. For each position, the L0 motion vector is first checked, and then the L1 motion vector. That is, the checking order is (B₀, L0), (B₀, L1), (A₀, L0), (A₀, L1), . . . , (B₂, L1). For another example, the L1 motion vector is first checked, and then the L0 motion vector.

In one embodiment, the inherited model parameters can also be from the block positions in the patterns described in earlier paragraphs. The positions are centred at (x′, y′), where x′=x+Δx and y′=y+Δy. The horizontal and vertical displacement Δx and Δy are determined based on the selected motion vector of the neighbouring block. For example, if the reference picture of the selected motion vector and the collocated picture are the same picture, Δx equals to the horizontal part of the selected motion vector and Δy equals to the vertical part of the selected motion vector. If the horizontal part or the vertical part of the selected motion vector is fractional, Δx equals to the horizontal part of the selected motion vector after rounding and Δy equals to the vertical part of the selected motion vector after rounding. The rounding method used can be but not limited to the following methods: rounding toward negative infinity, rounding toward positive infinity, rounding toward zero, or rounding to the nearest integer (e.g., rounding away from zero, rounding half up, rounding half down, . . . ). For another example, if the reference picture of the selected motion vector and the collocated picture are not the same. The reference picture can be one of the pictures in the reference list, while the collocated picture is signalled in the picture/slice header. Let the POC distance between the current picture and the reference picture of the selected motion vector be tb, and the POC distance between the current picture and the collocated picture be td, the selected motion vector be (mv_x, mv_y). Δx=mv_x*(td/tb) and Δy=mv_y*(td/tb). If mv_x*(td/tb) or mv_y*(td/tb) is fractional, Δx equals to mv_x*(td/tb) after rounding or the horizontal part of the selected motion vector after rounding and Δy equals to mv_y*(td/tb) after rounding or the vertical part of the selected motion vector after rounding. The rounding method used can be, but not limited to, the following methods: rounding toward negative infinity, rounding toward positive infinity, rounding toward zero, or rounding to the nearest integer (e.g., rounding away from zero, rounding half up, rounding half down, . . . ).

In one embodiment, the inherited model parameters are derived by using the luma and chroma reconstruction samples of the collocated block. Let the current block position be at (x, y) and the block size is w×h. The collocated block is a block positioned at (x′, y′) in the collocated picture with block size w×h, when the inherited model is from position (x′, y′). For another example, the collocated block can be a block positioned at (x′, y′) in the collocated picture with block size m×n, where m and n are fixed positive values. For example, the collocated block can be at (x, y). For another example, if Δx and Δy are the L0 horizontal and vertical motion vectors of the neighbouring block, and the collocated picture is the L0 reference picture indicated by the L0 motion vector of the neighbouring block, the collocated block can be at (x+Δx, y+Δy) in the collocated picture. (x′, y′) can be the block positions in the patterns described in earlier paragraphs. For example, (x′, y′) can be (x+αₓᵢ×w, y+α_{yi}×h), (x+xₓᵢ×w, y−α_{yi}×h), (x−αₓᵢ×w, y+α_{yi}×h), (x−αₓᵢ×w, y−α_{yi}×h), (x+αₓᵢ×w, y), (x−αₓᵢ×w, y), (x, y+α_{yi}×h), or (x, y−α_{yi}×h).

In one embodiment, the cross-component parameter model can be inherited from more than one previous coded picture. The cross-component parameter model can be inherited from any picture in a picture set, which contains N previous coded pictures. An index can be signalled/parsed in the bitstream to indicate the selected picture. The index ranges from 0 to N−1. In one sub-embodiment, the picture whose POC difference between itself and the current picture is smaller is associated with the smaller index. In another sub-embodiment, the picture whose QP difference between itself and the current picture is smaller is associated with the smaller index. In another sub-embodiment, the picture whose QP is smaller is associated with the smaller index. In another sub-embodiment, the picture whose QP is larger is associated with the smaller index.

### I.4 Inheriting Non-Adjacent Spatial Neighbouring Models

In one embodiment, the inherited model parameters can be from blocks that are non-adjacent spatial neighbouring blocks. The models from blocks at pre-defined positions are added into the candidate list in a pre-defined order.

In one sub-embodiment, the pre-defined positions and the pre-defined order are the same as those of non-adjacent spatial neighbouring candidates for inter merge mode.

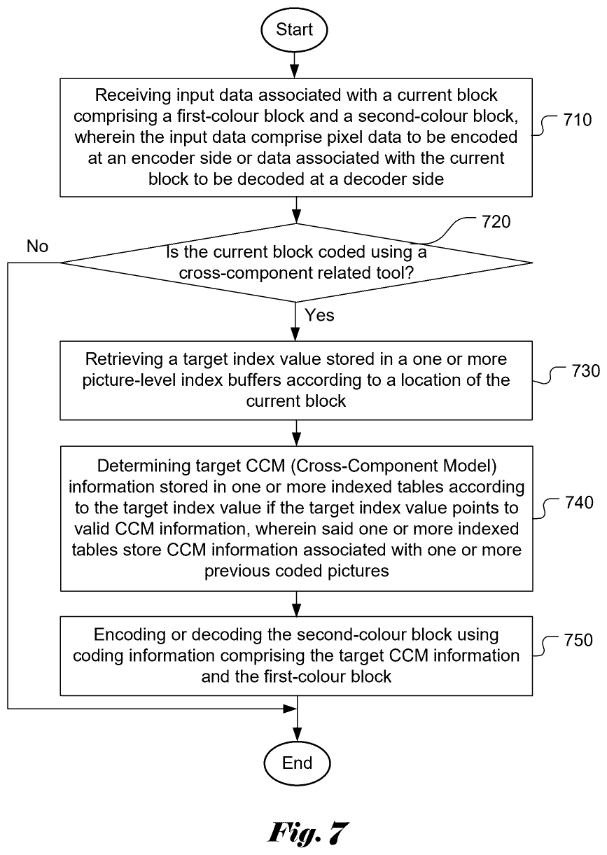

In one sub-embodiment, the pre-defined positions and the pre-defined order are as depicted in FIG. 6A and FIG. 6B. The positions of the numbered squares are the pre-defined positions. The number inside each square indicates the pre-defined order. Positions in Pattern 1 (610) is added into the list before positions in Pattern 2 (620). The distance between each pre-defined positions are proportional to the width and height of the current block.

In one embodiment, there is a maximum number of inherited models from non-adjacent spatial neighbours that can be added into the candidate list, and the maximum number is smaller than the number of pre-defined positions.

In one embodiment, let the current block position be (x, y) and the block size be w×h. The two value sets ax and ay are defined as:

$${α}_{x} = \{ {α}_{x 1} , {α}_{x 2} , {α}_{x 3} , … , {α}_{x n} \} , {α}_{x i} < {α}_{x j} if i < j$$

$${α}_{y} = \{ {α}_{y 1} , {α}_{y 2} , {α}_{y 3} , … , {α}_{y n} \} , {α}_{y i} < {α}_{y j} if i < j$$

All values in ax and ay are positive numbers. Let x′=x+Δx and y′=y+Δy. The inherited model parameters can be from the positions determined by x′ and y′. For example, the inherited model parameters can be from the block at positions (x′+αₓᵢ×w, y′+α_{yi}×h), (x′+αₓᵢ×w, y′−α_{yi}×h), (x′−αₓᵢ×w, y′+α_{yi}×h), (x′−αₓᵢ×w, y′−α_{yi}×h), (x′+αₓᵢ×w, y′), (x′−αₓᵢ×w, y′), (x′, y′+α_{yi}×h), (x′, y′−α_{yi}×h), (x′+αₓᵢ×w, 0), (x′−αₓᵢ×w, 0), (0, y′+α_{yi}×h), or (0, y′−α_{yi}×h). For another example, let δx and Sy be two fixed positive numbers. The inherited model parameters can be from the block at positions (x′+αₓᵢ×δx, y′+α_{yi}×δy), (x′+αₓᵢ×δx, y′−α_{yi}×δy), (x′−αₓᵢ×δx, y′+α_{yi}×δy), (x′−αₓᵢ×δx, y′−α_{yi}×δy), (x′+αₓᵢ×δx, y′), (x′−αₓᵢ×δx, y′), (x′, y′+α_{yi}×δy), (x′, y′−α_{yi}×δy), (x′+αₓᵢ×δx, 0), (x′−αₓᵢ×δx, 0), (0, y′+α_{yi}×δy), or (0, y′−α_{yi}×δy). For another example, the inherited model parameters can be from the block at some pre-defined positions relative to (x′, y′) of the previous coded slices/picture. The positions can be (x′, y′), (x′+w−1, y′), (x′, y′+h−1), (x′+w−1, y′+h−1), or (x′+w/2, y′+h/2). For another example, the positions can be (x′−1, y′), (x′, y′−1), (x′−1, y′−1), (x+w, y′), (x′+w−1, y′−1), (x′+w, y′−1), (x′, y′+h), (x′−1, y′+h−1), (x′−1, y′+h), (x′+w, y′+h−1), (x′+w−1, y′+h), or (x′+w, y′+h). For another example, the position can be (x′, y′), (x′, y′+h/2), (x′+w/2, y′), (x′+w/2, y′+h/2), (x′+w, y′), (x′, y′+h), or (x′+w, y′+h).

In one sub-embodiment, if the prediction mode of the current block is IBC, Δx and Δy can be set according to the horizontal and vertical block vectors of the current block. For example, Δx and Δy can be equal to the horizontal and vertical block vectors of the current block.

In another sub-embodiment, Δx and Δy can be set according to the horizontal and vertical block vectors of a neighbouring block. For example, Δx and Δy can be equal to the horizontal and vertical block vectors of a neighbouring block.

1.5 Inheriting Model Parameters from History Table

In one embodiment, the inherited model parameters can be from a cross-component model history table. The history table stores CCM information of valid previous coded blocks. The valid previous coded block refers to any blocks containing valid CCM information. The cross-component models in the history table can be added into the candidate list according to a pre-defined order. In one embodiment, the adding order of historical candidates can be from the beginning of the table to the end of the table. In another embodiment, the adding order of historical candidates can be from the end of the table to the beginning of the table.

In one embodiment, one cross-component model history table can be maintained for storing the previous cross-component model (i.e., CCM information), and the cross-component model history table can be reset at the start of the current picture, current slice, current tile, every M CTU rows or every N CTUs, where N and M can be any value greater than 0. In another embodiment, the cross-component model history table can be reset at the end of the current picture, current slice, current tile, current CTU row or current CTU.

In another embodiment, multiple history tables are used for storing different types of cross-component models. For example, the first history table is used for storing single model, and the second history table is used for storing multi-model. For another example, the first history table is used for storing gradient model, and the second history table is used for storing non-gradient model. For another example, the first history table is used for storing simple linear model (e.g., y=ax+b), and the second history table is used for storing complicated model (e.g., CCCM).

In one embodiment, when adding historical candidates from multiple history tables to the candidate list, the adding order can be from the beginning of to the end of a certain table, and then the next history table is added in the same order or in a reversed order.

I.6 Inheriting from Fusion Mode

Fusion mode refers to a mode that fuses two predictions to generate the final prediction. In the chroma intra fusion mode, a chroma intra prediction that is not generated using a cross-component prediction (CCP) coding tool (e.g., CCLM, MMLM, CCCM) is fused with another chroma intra prediction generated using a cross-component prediction coding tool. For example, a non-CCLM coded intra prediction and a CCLM coded intra prediction are fused together to obtain the final intra prediction.

In one embodiment, when inheriting the cross-component model parameters from the block/position coded by chroma intra fusion mode, the model parameters for obtaining the CCP coded intra prediction are inherited and further refined.

In one embodiment, in addition to inheriting and refining the CCP model parameters, the fusion weight, the coding mode of non-CCP coded intra prediction are also inherited. That is, the chroma intra fusion mode is inherited.

### 1.7 Constructing a Candidate List

In one embodiment, the candidate list is constructed by adding candidates in a pre-defined order until the maximum candidate number is reached. The candidates added can include all or some of the aforementioned candidates, but not limited to the aforementioned candidates. For example, the pre-defined order can be spatial adjacent candidates, temporal candidates, spatial non-adjacent candidates, historical candidates, and then default candidates.

In another embodiment, if all the pre-defined neighbouring and historical candidates are added but the maximum candidate number is not reached, some default candidates are added into the candidate list until the maximum candidate number is reached.

In one embodiment, the default candidates can be CCLM models. The scaling parameter α is from the set {0, 1/8, −1/8, +2/8, −2/8, +3/8, −3/8, +4/8, −4/8, . . . , +N/8, −N/8}, where N is a positive integer. The offset parameter β can be 1/(1<<bit_depth) or can be derived based on neighbouring luma and chroma samples. For example, if the average value of neighbouring luma and chroma samples are lumaAvg and chromaAvg, β=chromaAvg−α·lumaAvg. In one sub-embodiment, the inclusion order of the default candidates can depend on the absolute value and the sign of the scaling parameter α. For example, the default candidates are added into the list in the following order: α=0, 1/8, −1/8, +2/8, −2/8, +3/8, −3/8, +4/8, −4/8, . . . , +N/8, −N/8.

In another embodiment, a default candidate can be an earlier candidate with a delta scaling parameter refinement. The earlier candidate is a CCLM model. If the scaling parameter of an earlier candidate is a, the scaling parameter of a default candidate is (α+Δα). For example, Aa can be 1/8, −1/8, +2/8, −2/8, +3/8, −3/8, +4/8, −4/8, . . . , +N/8, −N/8, where N is a positive integer. The offset parameter β can be derived based on (α+Δα) and the average values of neighbouring luma and chroma samples of the current block. In one sub-embodiment, the earlier candidate is the first CCLM candidate added into the list. In one sub-embodiment, the inclusion order of the default candidates can depend on the absolute value and the sign of the refinement Δx. For example, the default candidates are added into the list in the following order: Δα=0, 1/8, −1/8, +2/8, −2/8, +3/8, −3/8, +4/8, −4/8, . . . , +N/8, −N/8.

### 1.8 Removing or Modifying Similar Neighbouring Model Parameters

When inheriting cross-component model parameters from other blocks as a candidate, the similarity between the inherited model and the existing models in the candidate list can be checked. If the inherited model of a candidate is similar to one of the existing models, the inherited model will not be included into the candidate list. Otherwise, the model is included.

In one embodiment, if a candidate position points to a CU which is the same one as that of the existing candidates, the model of the candidate is similar to that existing candidate and hence is not included.

In one embodiment, if the mode of the model of a candidate is not the same as that of the existing model, the model of a candidate is not similar to the existing model. For example, if the candidate is a CCCM model, and the existing model is a CCLM model, since CCCM is not the same as CCLM, these two models are not similar.

In one embodiment, the parameters of the inherited model of a candidate can be compared with the parameters of existing models. If all of the corresponding parameters are the same, or all the differences between the corresponding parameters are smaller than respective pre-defined thresholds, the two models are similar. Otherwise, they are not similar. For example, when the models are both CCLM mode, α, or α and β, of the inherited model can be compared with those of existing candidates to decide whether to include the model of a candidate or not. For example, if α, or a and β of the candidate is/are the same as those of the existing candidates, the model of the candidate is not included. For another example, if the difference of α, or α and β between the candidate and those of existing candidates is/are less than respective thresholds, the model of the candidate is not included. The thresholds can be adaptive based on coding information (e.g., the current block size or area). For example, when the models are both CCCM mode, the similarity of the CCCM parameters (c₀, to c₆) can be checked to decide whether to include the model of a candidate or not.

In one embodiment, the similarity of two models can be determined by computing the output of the model based on some pre-defined input. For example, when the models are both CCLM mode, it can compare (α×lumaAvg+B) with that of existing models, where lumaAvg is the average value of the neighbouring luma samples, to decide whether to include the model of a candidate or not. For example, if (α×lumaAvg+) of the candidate is the same as that of the existing candidates, the model of the candidate is not included. For example, if the difference of (α×lumaAvg+) between the candidate and one of existing candidates is less than a threshold, the model of the candidate is not included. The threshold can be adaptive based on coding information (e.g., the current block size or area).

In one embodiment, only partial model parameters are compared. For example, a CCLM candidate has scale and offset parameters, only the scale or the offset parameters of the inherited model are compared with those of existing candidates. If the scale or offset parameters of both models are the same or similar, the inherited model will not be included into the candidate list. For example, a CCCM candidate has c₀ to c₆ parameters, only n parameters (n<7) of the inherited models are compared with those of existing candidates. If all of the n parameters are the same or similar, the inherited model will not be included into the candidate list.

In one embodiment, it can apply a candidate model to the neighbouring reconstruction samples of the current block to generate prediction and compare the prediction with the prediction generated by applying the existing candidate models to the neighbouring reconstruction samples. If the difference value is less than or equal to a threshold, the model will not be included into the candidate list. For example, assume the applied result is

$${p}_{j}^{n e i}$$

and the corresponding results of the existing models in the candidate list are

$${p}_{0}^{n e i} to {p}_{i}^{n e i} .$$

### If

$$\vert {p}_{j}^{n e i} - {p}_{0}^{n e i} \vert < th , \vert {p}_{j}^{n e i} - {p}_{1}^{n e i} \vert < th , … , or \vert {p}_{j}^{n e i} - {p}_{i}^{n e i} \vert < th ,$$

the model will not be included into the candidate list. For the selection of the neighbouring reconstruction samples, it can choose the neighbouring reconstruction sample with the mαₓᵢ mal value, the neighbouring reconstruction sample with the minimal value, the mean/median/mode of the neighbouring reconstruction samples, the left-side neighbouring reconstruction samples, the above-side neighbouring reconstruction samples, or the above-left neighbouring reconstruction samples.

### II. Storing Temporal Models in an Indexed Table

In one embodiment, CCM information from previous coded slices/pictures is stored in a table, and a picture-level index buffer is created to store the index of the table. Every picture has its index buffer, and the index buffer has the same size as the picture. When referencing the CCM information at position (x, y) inside the collocated picture (defined in Section I.3 “Inheriting temporal neighbouring model parameters”), an index value is retrieved from the position (x, y) in the index buffer of the collocated picture. If the index value indicates that no CCM information is available at position (x, y), no CCM information can be referenced. Otherwise, an item in the table indicated by the index value is obtained as the CCM information to be referenced.

In one sub-embodiment, the table to store CCM information is a picture-level table. CCM information from each picture is stored in a separate table.

In another sub-embodiment, one table is created to store CCM information from all pictures.

In another sub-embodiment, one table is created for each temporal id. CCM information from the layer with the same temporal id is stored in the same table.

In another sub-embodiment, several tables are used to store CCM information from one picture. A picture can be divided into several regions, with each region corresponding to its own table.

In one embodiment, after storing CCM information at position (x, y) of the current encoding/decoding picture into the corresponding table, the table index value of that CCM information is saved in the index buffer of the current encoding/decoding picture at position (x, y). If no CCM information is available at position (x, y) (e.g., the CU covering position (x, y) is not coded in cross-component prediction modes, such as CCLM, MMLM, CCCM, CCCM multi-models, chroma fusion, or other cross-component models), the value at position (x, y) in the index buffer is set to indicate that no CCM information is available.

In one embodiment, if CCM information is not available at position (x, y) of the current encoding/decoding picture, the index value at position (x, y) in the index buffer of the collocated picture can be stored at position (x, y) in the index buffer of the current encoding/decoding picture.

In one embodiment, when CCM information is not available at position (x, y) of the current encoding/decoding picture, if the current encoding/decoding picture is an inter picture and if the index value at position (x, y) in the index buffer of the collocated picture indicates a saved model (i.e., a stored CCM information) in the corresponding table of the collocated picture, the saved model is then stored in the corresponding table of the current encoding/decoding picture, and the table index value of the saved model in the corresponding table of the current encoding/decoding picture is saved in the index buffer of the current encoding/decoding picture at position (x, y). Otherwise, the value at position (x, y) in the index buffer of the current encoding/decoding picture is set to indicate that no CCM information is available.

In one embodiment, if CCM information is not available at position (x, y) of the current encoding/decoding picture, if the current encoding/decoding picture is an inter picture and if the index value at position (x, y) in the index buffer of the collocated picture of the current picture indicates a saved model (i.e., a stored CCM information) in the corresponding table of the collocated picture. The saved model can be inserted into the table corresponding to the current block, and the index of the saved model in the current table (i.e., the corresponding table of the current block) can be stored at position (x, y) in the index buffer of the current encoding/decoding picture.

In another embodiment, when deleting a CCM information from a table, all values in the index buffers that indicate to use the to-be-deleted CCM information are reset to indicate that no CCM information is available. In another embodiment, when deleting a CCM information from a table, assume the index value of the to-be-deleted CCM information is N, all values in the index buffer that are greater than N will be decreased by 1.

In one embodiment, there's a maximum size limit for a table used to store the CCM information. A high-level syntax can be signalled in SPS, PPS, PH or SH to indicate the maximum size limit. If a table has reached its maximum size when attempting to store new CCM information into the table, the new CCM information is not stored into the table. In another embodiment, if a table has reached its maximum size when attempting to store new CCM information into the table, the CCM information stored earliest is deleted to free up space in the table.

In one embodiment, when attempting to store the CCM information at position (x, y) of the picture into the table, the similarity between the to-be-added CCM information and the existing CCM information in the table can be compared. If the to-be-added CCM information is similar to an existing CCM information, the to-be-added CCM information will not be stored, and the index of that existing CCM information is stored at the position (x, y) in the index buffer. Otherwise, the to-be-added CCM information is stored in the table, and the index value of the to-be-added CCM information is stored at the position (x, y) in the index buffer. The similarity between CCM information can be determined through methods the same as methods used to compare models when adding models into the merge candidate list, as described in Section I.8 “Removing or modify similar neighbouring model parameters”

In one embodiment, the table can be reset at the beginning of encoding/decoding of an IDR (Instantaneous Decoder Refresh) picture. In another embodiment, the table can be reset after encoding/decoding of an IDR picture. In another embodiment, the table can be reset at the beginning of encoding/decoding of a CRA (Clean Random Access) picture. In another embodiment, the table can be reset after encoding/decoding of a CRA picture. In another embodiment, the reset mechanism can be the same as that used in parameter set or reference pictures.

In one embodiment, indexes stored in the index buffer can only be referenced by a unit larger than or equal to the smallest coding unit. For example, if the smallest coding unit is 4×4, the indexes can be reference by an 8×8 grid. That is, one 8×8 block has the same index value. The positions in the same grid have the same index value. To retrieve index value at position (x, y), the position (x, y) can be rounded to a point on the grid (e.g., (x>>3)<<3, (y>>3)<<3) or to its nearest point on the grid.

In one embodiment, the CCM information to be stored in the table can be explicitly signalled in the bitstream in SPS, PPS, PH or SH. The corresponding positions of the CCM information can also be signalled.

Any of the foregoing proposed methods of CCM prediction using one or more indexed tables can be implemented in encoders and/or decoders. For example, any of the proposed methods of CCM prediction using one or more indexed tables can be implemented in an inter/intra/prediction module of an encoder, and/or an inter/intra/prediction module of a decoder. Alternatively, any of the proposed methods of CCM prediction using one or more indexed tables can be implemented as circuits coupled to the inter/intra/prediction module of the encoder and/or the inter/intra/prediction module of the decoder, so as to provide the information needed by the inter/intra/prediction module.

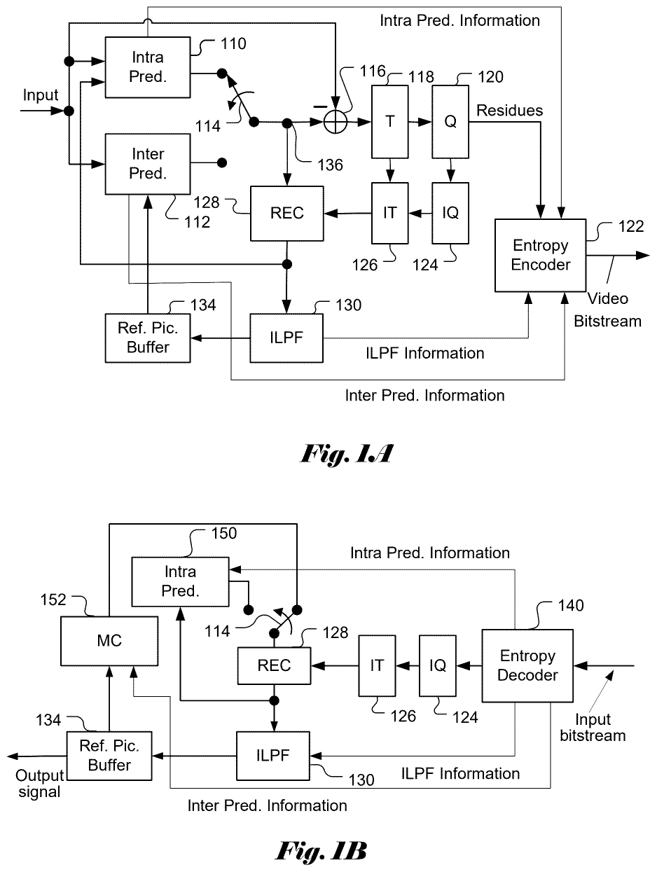

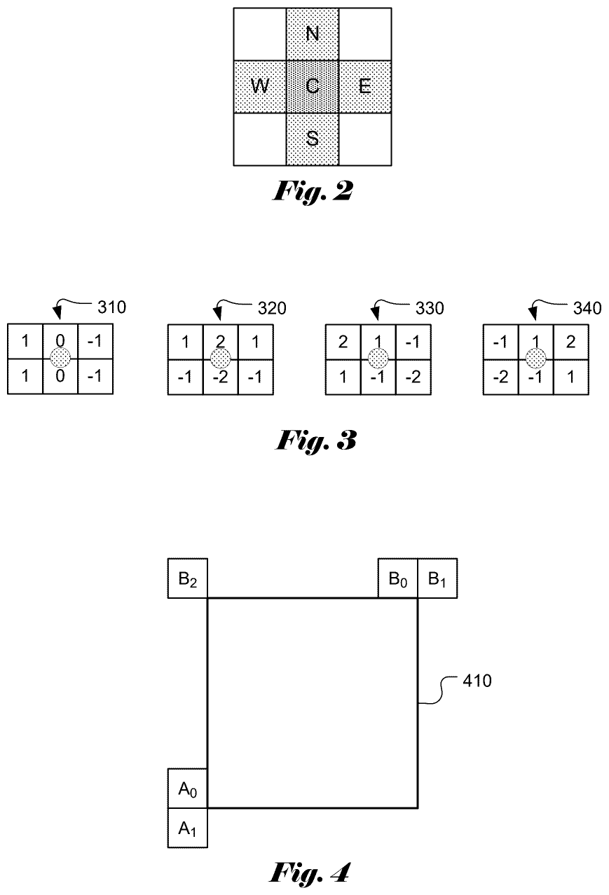

The CCM prediction using one or more indexed tables as described above can be implemented in an encoder side or a decoder side. For example, any of the proposed c method can be implemented in an Intra/Inter coding module (e.g. Intra Pred. 150/MC 152 in FIG. 1B) in a decoder or an Intra/Inter coding module in an encoder (e.g. Intra Pred. 110/Inter Pred. 112 in FIG. 1A). Any of the proposed candidate derivation method can also be implemented as a circuit coupled to the intra/inter coding module at the decoder or the encoder. However, the decoder or encoder may also use additional processing unit to implement the required cross-component prediction processing. While the Intra Pred. units (e.g. unit 110/112 in FIG. 1A and unit 150/152 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

FIG. 7 illustrates a flowchart of an exemplary video coding system that uses one or more indexed tables for storing cross-component model (CCM) information associated with previous coded pictures and the CCM is retrieved according to an index value stored in a picture-level index buffer. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block comprising a first-colour block and a second-colour block is received in step 710, wherein the input data comprise pixel data to be encoded at an encoder side or data associated with the current block to be decoded at a decoder side. Whether the current block is coded using a cross-component related tool is checked in step 720. If the current block is coded using the cross-component related tool (i.e., the “Yes” path from step 720), steps 730-750 are performed. Otherwise (i.e., the “No” path from step 720), steps 730-750 are skipped. In step 730, a target index value stored in one or more picture-level index buffers is retrieved according to a location of the current block is retrieved. In step 740, target CCM (Cross-Component Model) information stored in one or more indexed tables is determined according to the target index value if the target index value points to valid CCM information, wherein said one or more indexed tables store CCM information associated with one or more previous coded pictures. In step 750, the second-colour block is encoded or decoded using coding information comprising the target CCM information and the first-colour block.

The flowchart shown is intended to illustrate an example of video coding according to the present invention. A person skilled in the art may modify each step, re-arranges the steps, split a step, or combine steps to practice the present invention without departing from the spirit of the present invention.

In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of coding colour pictures using coding tools including one or more cross component models related modes, the method comprising:
receiving input data associated with a current block comprising a first-colour block and a second-colour block, wherein the input data comprise pixel data to be encoded at an encoder side or data associated with the current block to be decoded at a decoder side; and
if the current block is coded using a cross-component related tool:
retrieving a target index value stored in one or more picture-level index buffers according to a location of the current block;
determining target CCM (Cross-Component Model) information stored in one or more indexed tables according to the target index value if the target index value points to valid CCM information, wherein said one or more indexed tables store CCM information associated with one or more previous coded pictures; and
encoding or decoding the second-colour block using coding information comprising the target CCM information and the first-colour block.

2. The method of claim 1, wherein said one or more indexed tables to store the CCM information correspond to one or more picture-level tables.

3. The method of claim 2, wherein one indexed table is created to store the CCM information from each of previous coded pictures.

4. The method of claim 2, wherein one indexed table is created to store the CCM information from all the previous coded pictures.

5. The method of claim 2, wherein one indexed table is created to store the CCM information for the previous coded pictures associated with each temporal ID (Identifier).

6. The method of claim 5, wherein the CCM information from a layer for the previous coded pictures with a same temporal ID is stored in a same table.

7. The method of claim 1, wherein multiple indexed tables are used to store the CCM information associated with one previous coded picture.

8. The method of claim 7, wherein one previous coded picture is divided into multiple regions and each of the multiple regions uses an individual indexed table.

9. The method of claim 1, wherein the target index value for the target CCM information at the location of the current block is saved at the location of the current block in said one or more picture-level index buffers of a current picture being encoded or decoded after storing the target CCM information into one or more corresponding indexed tables of the current block of the current picture being encoded or decoded.

10. The method of claim 9, wherein when storing the target CCM information at the location of the current block into said one or more indexed tables, similarity between the target CCM information and existing CCM information in said one or more indexed tables are compared.

11. The method of claim 10, wherein if the target CCM information is similar to the existing CCM information in one or more entries of said one or more indexed tables, the target CCM information is not stored.

12. The method of claim 11, wherein a corresponding index associated with the existing CCM information is stored at the location of the current block in said one or more picture-level index buffers.

13. The method of claim 10, wherein the similarity is determined by comparing mode, one or more parameters, or both between the target CCM information and the existing CCM information.

14. The method of claim 1, wherein if no CCM information is available at the location of the current block, a corresponding index value at the location of the current block in said one or more picture-level index buffers is set to indicate no CCM information available.

15. The method of claim 1, wherein if no CCM information is available at a target location of a current picture and if a corresponding index value at the target location in said one or more picture-level index buffers of a collocated picture indicates saved CCM information in one or more corresponding indexed tables, the saved CCM information is stored at the indexed table corresponding to the target location of the current picture and the target index value for the saved CCM information in the indexed table corresponding to the target location of the current picture is saved at the target location in said one or more picture-level index buffers of the current picture.

16. The method of claim 1, wherein when deleting to-be-deleted CCM information from said one or more indexed tables, all index values in said one or more picture-level index buffers indicating to use the to-be-deleted CCM information are reset to indicate no CCM information available.

17. The method of claim 1, wherein when deleting to-be-deleted CCM information from said one or more indexed tables, all index values in said one or more picture-level index buffers having values greater than N are decreased by 1 if the index value for the to-be-deleted CCM information is N.

18. The method of claim 1, wherein a maximum number of entries for said one or more indexed tables is limited to a maximum size.

19. The method of claim 18, wherein a high-level syntax is signalled or parsed in SPS (Sequence Parameter Size), PPS (Picture Parameter Size), PH (Picture Header) or SH (Slice Header) to indicate the maximum size.

20. The method of claim 18, wherein said one or more indexed tables reach the maximum size, oldest CCM information is deleted to free up space for new CCM information in said one or more indexed tables.

21. The method of claim 1, wherein said one or more indexed tables are reset at beginning of encoding/decoding of an IDR (Instantaneous Decoder Refresh) or CRA (Clean Random Access) picture or after said encoding/decoding of the IDR or CRA picture.

22. The method of claim 1, wherein one or more indexes stored in said one or more picture-level index buffers are only referenced by a coding block larger than or equal to a smallest coding unit.

23. An apparatus for video coding, the apparatus comprising one or more electronics or processors arranged to:
receive input data associated with a current block comprising a first-colour block and a second-colour block, wherein the input data comprise pixel data to be encoded at an encoder side or data associated with the current block to be decoded at a decoder side;
if the current block is coded using a cross-component related tool:
retrieve a target index value stored in one or more picture-level index buffers according to a location of the current block;
determine target CCM (Cross-Component Model) information stored in one or more indexed tables according to the target index value if the target index value points to valid CCM information, wherein said one or more indexed tables store CCM information associated with one or more previous coded pictures; and
encode or decode the second-colour block using coding information comprising the target CCM information and the first-colour block.
